(19) United States
(12) Patent Application Publication
(10) Pub. No.: US 2025/0263244 A1
(43) Pub. Date: Aug. 21, 2025

(54) AUGER MACHINE FOR MOVING GRAIN AND OTHER FLOWABLE MATERIALS

(71) Applicant: Kevin Curry, Wilmington, OH (US)

(72) Inventor: Kevin Curry, Wilmington, OH (US)

(21) Appl. No.: 18/582,562

(22) Filed: Feb. 20, 2024

(51) Int. Cl. B65G 33/14; B65G 41/00

(52) U.S. Cl. CPC B65G 33/14; B65G 41/002

(57) ABSTRACT

An embodiment of the present invention is an auger machine for moving grain and other flowable materials, comprising: a base formed of a plurality of rigid base ribs extending between and coupled to at least two rigid base bars; at least one attachment means coupled to each of the plurality of elongate rib members; a hollow auger tube having an intake end and a discharge end; and two articulating lifting members connected to the auger tube, wherein the articulating lifting members are configured to lift by a hydraulic lift.

### BACKGROUND

The present invention relates to augers and, more particularly, to augers for moving grain and other flowable materials.

Grain storage and transport is vital for modern society. Proper grain storage and transportation allows for grain to have a significantly longer life, thereby creating greater food security for people around the world. Throughout history, the storage and transportation of grain has been a manually intensive process. As technology has advanced, many portions of the grain cultivation and harvesting process have become incredibly efficient and allow for immense quantities of grain to be collected and stored in a relatively short period of time.

Machines, such as short grain augers, have also been created to help with the movement of grain from storage to transportation vehicles, and vice versa. These short-grain augers generally rely on a user to move the auger by hand to get the auger in the proper position to move the grain. Many conventional load-out type augers require a user to lift an intake end of the auger, push or pull the auger via small wheels attached to the auger, and maneuver the auger into the desired position.

However, many of these augers are heavy and difficult to move. Further, grain is often stored in or transported from areas with muddy, uneven terrain. The heavy and cumbersome designs for conventional short-grain augers and difficult terrain makes moving and positioning conventional augers labor intensive, time-consuming, and potentially hazardous for the user. Additionally, because conventional short grain augers are difficult to maneuver, these augers are often left outdoors when not in use, leading the augers to require more maintenance and upkeep to avoid breaking down.

As can be seen, there is a need for an auger machine that is easy to maneuver such that it reduces the effort needed and the time taken to move the auger into position. Further, there is a need for an auger machine that is easily moved so as to reduce the risk of injury to the user while moving the auger, and so that the auger may be easily moved indoors to minimize or prevent degradation of the auger.

### SUMMARY OF INVENTION

The present invention solves these problems with conventional auger machines by allowing available equipment such as a skid loader or tractor to move the auger into position. Thus, the auger is easier to move and position, and the risk of strain or injury to a user of the auger is reduced. Further, the present invention allows the auger to moved with enough ease that it can be stored indoors when not in use, thereby minimizing or preventing degradation of the auger.

According to an aspect of the present invention, there is provided an auger machine for moving grain and other flowable materials, comprising: a base formed of a plurality of rigid base ribs extending between and coupled to at least two rigid base bars; at least one attachment means coupled to each of the plurality of elongate rib members; a hollow auger tube having an intake end and a discharge end; and two articulating lifting members connected to the auger tube, wherein the articulating lifting members are configured to lift by a hydraulic lift.

### BRIEF DESCRIPTION OF THE DRAWINGS

FIG. 1 is a perspective view of an auger machine according to an embodiment of the present invention; and

FIG. 2 illustrates the auger machine from another perspective.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an auger machine configured to move grain and similarly flowable materials. The auger machine comprises a base formed of a plurality of rigid base ribs extending between and coupled to at least two rigid base bars. The plurality of base ribs and plurality of base bars may be coupled to one another by known means such as welding or nut and bolt assemblies or may alternatively be integrally formed together.

At least one attachment means is coupled to each of the plurality of elongate rib members via welding, nut and bolt assemblies, or other known means. The at least one attachment means is configured to allow the base, and thus the auger machine, to be attached to and/or be moved from the side of the auger machine by transport machinery, such as a forklift, tractor, skid loader, or similar machinery.

At least a first and second rigid support member are attached to at least two of the plurality of base ribs. Each of the at least first and second rigid support members comprises a plurality of support bore holes and the at least two of the plurality of base ribs comprise a plurality of base bore holes. The plurality of support bore holes and plurality of base bore holes may be aligned to allow for the base to be pivotally coupled to the at least first and second rigid support members via nut and bolt assemblies, or similar known fastening means.

The first rigid support member is pivotally coupled to the at least two of the plurality of base ribs at a first end of the first rigid support member and is rigidly coupled to a first end of a pivot frame at a second end of the first rigid support member. The second rigid support member is pivotally coupled to the at least two of the plurality of base ribs at a first end of the second rigid support member and is pivotally coupled to a first tube joint of an auger tube at a second end of the second rigid support member by known means, such as a nut and bolt assembly.

A third rigid support member is pivotally coupled to a second end of the pivot frame at a first end of the third rigid support member and a second tube joint of the auger tube at a second end of the third rigid support member by known means, such as a nut and bolt assembly. Further, a tube support may be attached adjacent to the first end of the third rigid support member to support the auger tube when the auger machine is in the transport position. An optional fourth rigid support member may be pivotally coupled to a central portion of the pivot frame at a first end of the fourth rigid support member and slidably coupled at a second end of the fourth rigid support member to at least one toothed slot formed within the second rigid support member.

A lifting mechanism, such as a first hydraulic cylinder, is pivotally coupled to the first and third rigid support members and is configured to allow the auger tube to be move between an operating position and a transport position. A locking mechanism is provided to lock the auger machine into the operating or transport position. The locking mechanism may be formed as a second hydraulic cylinder or as a hydraulic lock.

The second hydraulic cylinder acts as the locking mechanism when the second hydraulic cylinder is pivotally coupled to the at least two of the plurality of base ribs at a first end of the second hydraulic cylinder, and a second end of the second hydraulic cylinder is pivotally coupled to the second end of the first rigid support member. Alternatively, the hydraulic lock may be fastened to the second end of the fourth rigid support member and may be configured to cooperate with the at least one toothed slot of the second rigid support member.

The locking mechanism may be automatically engaged. When using the second hydraulic cylinder, the first and second hydraulic cylinders are arranged relative to one another such that they cooperate to lock the auger machine into the operating position and into the transport position. When using the hydraulic lock, the locking mechanism biases against at least one tooth of the at least one toothed slot so as to lock the second end of the fourth rigid support member in place relative to the second rigid support member.

The auger tube is hollow and comprises a free and open-ended intake end and a discharge end. The intake end allowing grain or other flowable material to be taken into the auger tube substantially parallel to the longitudinal axis of the auger tube. The discharge end has a discharge opening allowing grain and other flowable material to be discharged from the auger tube substantially perpendicular to the longitudinal axis of the auger tube.

A screw conveyor comprising an auger flighting is slidably housed within the auger tube and extends the full length of the auger tube. At the discharge end of the auger tube, the screw conveyor is engaged with and spun by a motor via a belt or gear drive The motor and drive are fastened to a mounting flange, such as by nut and bolt assemblies. The mounting flange is securely coupled to the discharge end of the auger tube through known means, such as welding.

The present invention thus avoids the issues involved with having one person strain and potentially injure themselves while trying to move an auger machine. The present invention allows the auger machine to be hydraulically lifted or lowered, for example to reduce intake height and/or to reach a desired discharge point, thereby making positioning of the auger easier. Further, the present invention allows transport machinery to be used to move the auger machine into position, reducing the potential for injury to a user and making it easier to move the auger machine into position.

It should be noted that the materials used to form the present invention are not particularly limited. For example, the base and support structure of the present invention may be formed of metals, composites, or other similarly durable and strong materials. Further the method of manufacture of the present invention is not particularly limited. For example, the base and support structure may be formed through manufacturing techniques such as welding, nut and bolt assemblies, machining, casting, molding or other conventionally known manufacturing methods.

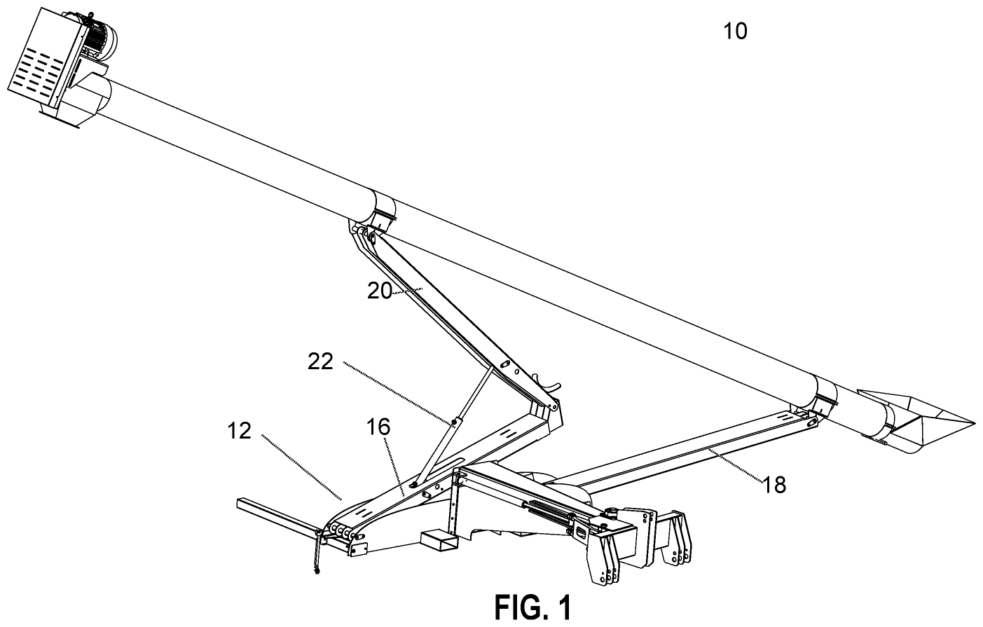

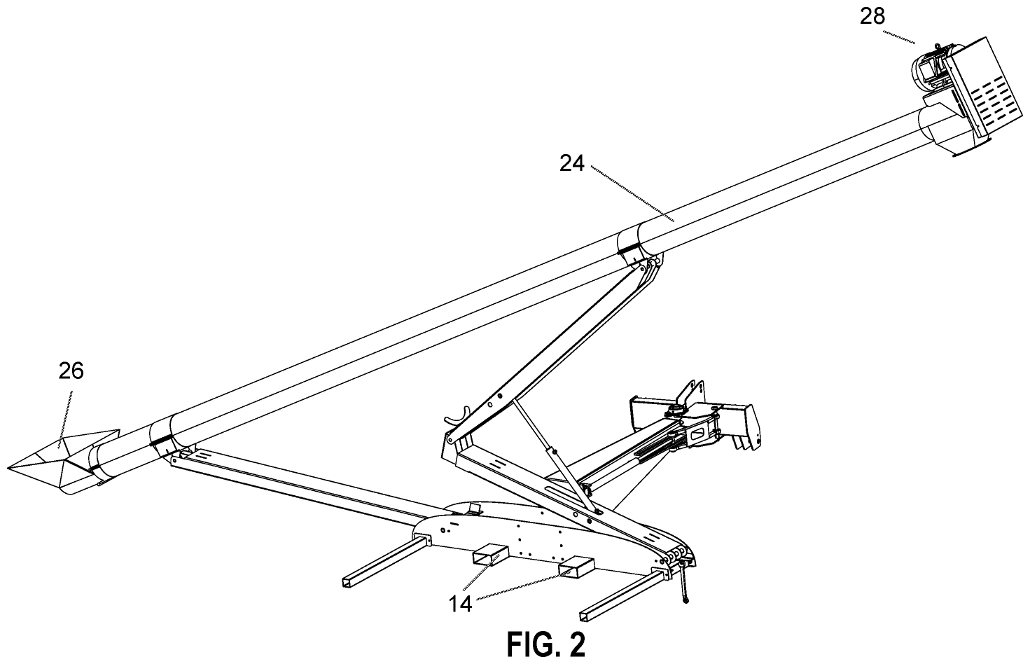

Referring now to FIGS. 1 and 2, an auger machine according to an embodiment of the present invention is depicted. The auger machine comprises a preferably steel base formed of four spaced apart base ribs extending between and preferably welded to two base bars. Two fork pockets, that are preferably steel, are preferably welded to central portions of each of the four spaced apart base ribs, and two bracing elements may additionally be welded to each weld joint connection between the base ribs and fork pockets. The fork pockets are configured to allow elements such as the forks of a forklift to pass through the fork pockets and allow the forklift to carry and move the auger machine.

In FIGS. 1 and 2, the following components are illustrated:
10—auger assembly
12—base
14—fork pockets
16—first articulating lifting member
18—second rigid support member
20—second articulating lifting member
22—hydraulic piston cylinder assembly
24—auger tube
26—intake
28—discharge end

Additional means may be used to connect the auger machine to transport equipment. Examples include, a skid loader attachment plate that enables a skid loader to move the auger machine, or a 3 point hitch system attachment to allow a tractor to move the auger machine. Further, while the attachment mechanisms shown allow the auger machine to be moved from a position that is perpendicular to the longitudinal axis of the auger tube, the auger machine may also be moved from a position that is parallel to the longitudinal axis of the auger tube.

A first and second rigid support member are attached to two of the base ribs spanning a center of the base. Each of the first and second rigid support members have support bore holes that correspond to base bore holes formed in the two center spanning base ribs. Respective first ends of the first and second rigid support members may thus pivotally coupled to the two center spanning base ribs via the support and base bore holes and nut and bolt assemblies. A second end of the first rigid support member is rigidly coupled to a first end of a pivot frame, and a second end of the second rigid support member is pivotally coupled to a first tube joint of an auger tube.

A first and second end of a third rigid support member is pivotally coupled to a second end of the pivot frame and a second tube joint of the auger tube, respectively. A tube support is attached to the third rigid support member to support the auger tube when the auger machine is in the transport position. A first end of a fourth rigid support member is pivotally coupled to a central portion of the pivot frame and a second end of the fourth rigid support member is slidably coupled to toothed slots formed within opposing sides of the second rigid support member.

A preferably hydraulic lift is pivotally coupled to the first and third rigid support members and is configured to allow the auger tube to be move between an operating position and a transport position. A preferably hydraulic lock is fastened to the second end of the fourth rigid support member and is configured to cooperate with the toothed slots. Oil may be supplied to hydraulic lift and hydraulic lock so that the increased oil pressure releases hydraulic lock valves and allows the hydraulic lift and hydraulic lock to move the auger machine into a desired position of operation or transport.

When the auger machine is in the desired position, the oil pressure may be decreased, such that the hydraulic lock valves automatically lock the hydraulic cylinder and hydraulic lock into the desired position. Additionally, the hydraulic lock cooperates with the teeth in the toothed slots to lock the fourth rigid support member in place relative to the second rigid support member, and thus locks the rest of the auger machine in position. While the auger machine is preferably locked in either the operating or transport position, the hydraulic lock may be configured to automatically lock when the auger machine in any desired position between the operating and transport positions.

The auger tube is a hollow preferably steel tube with an intake end and a discharge end. The intake end is open and free to be placed low and adjacent the grain to be moved, with the grain entering the intake end substantially parallel to the longitudinal axis of the auger tube. The discharge end has a discharge opening pointed substantially perpendicular to the longitudinal axis of the auger tube through which the grain may discharge.

A screw conveyor having an auger flighting is slidably housed within the auger tube and extends the full length of the auger tube. At the discharge end of the auger tube, the screw conveyor is engaged with and spun by a motor via a gearbox. A mounting frame is integrally formed with or welded to the discharge end and the motor and gearbox are fastened to the mounting frame.

In an alternative embodiment of the auger machine of the present invention, the auger machine may be formed without a fourth rigid support member, a hydraulic lock, or at least one toothed slot in the second rigid support member. The auger machine may instead comprise a second hydraulic cylinder fastened to the first rigid support member and the two center spanning base ribs. The second hydraulic cylinder cooperates with the first hydraulic cylinder to lift or lower the auger machine into a desired position and lock the auger machine into position through the use of hydraulic lock valves within the first and second hydraulic cylinders.

While the present invention is discussed primarily in terms of moving grain, the present invention may be used for materials that are movable similar to grain, such as fertilizer, lime, or feed. It should be understood, of course, that the foregoing relates to exemplary embodiments of the invention and that modifications may be made without departing from the spirit and scope of the invention as set forth in the following claims. Many other embodiments will be apparent to those of skill in the art upon reviewing the above description. Other embodiments may be utilized and derived therefrom, such that structural and logical substitutions and changes may be made without departing from the scope of this disclosure.

Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. An auger machine for moving grain and other flowable materials, comprising:
a base formed of a plurality of rigid base ribs extending between and coupled to at least two rigid base bars;
at least one attachment means coupled to each of the plurality of elongate rib members;
a hollow auger tube having an intake end and a discharge end; and
two articulating lifting members connected to the auger tube, wherein the articulating lifting members are configured to lift by a hydraulic lift.

2. The auger machine for moving grain and other flowable materials of claim 1, further comprising a locking mechanism.

3. The auger machine for moving grain and other flowable materials of claim 2, wherein the locking mechanism is a hydraulic cylinder or a hydraulic lock

4. The auger machine for moving grain and other flowable materials of claim 1, further comprising a rigid support member.

5. The auger machine for moving grain and other flowable materials of claim 1, wherein the hydraulic lift is a piston cylinder assembly.

6. The auger machine for moving grain and other flowable materials of claim 1, wherein the auger tube is made of steel.

7. The auger machine for moving grain and other flowable materials of claim 1, further comprising a screw conveyor having an auger flighting slidably housed within the auger tube and extending the full length of the auger tube.

8. The auger machine for moving grain and other flowable materials of claim 7, wherein the screw conveyor is engaged with and spun by a motor via a gearbox.

9. The auger machine for moving grain and other flowable materials of claim 1, wherein the discharge end of the auger tube has a discharge opening pointed substantially perpendicular to the longitudinal axis of the auger tube.

10. The auger machine for moving grain and other flowable materials of claim 2, further comprising teeth in toothed slots cooperating with the hydraulic lock.
